(19) United States
(12) Patent Application Publication
(10) Pub. No.: US 2026/0296074 A1
(43) Pub. Date: Oct. 1, 2026

(54) PRINTER AND A METHOD FOR PRINTING ON ROLLS OF WEB

(71) Applicant: CANON KABUSHIKI KAISHA, Tokyo (JP)

(72) Inventor: Stan P. VAN BOHEEMEN, Eindhoven (NL)

(21) Appl. No.: 19/631,385

(22) Filed: Mar. 27, 2026

(30) Foreign Application Priority Data
Mar. 27, 2025 (EP) 25166517.0

(51) Int. Cl. B41J 15/04; B41J 3/46; B41J 11/00; B41J 29/00; G06F 11/07

(52) U.S. Cl. CPC B41J 15/048; B41J 3/46; B41J 11/0095; B41J 29/00; G06F 11/0733; G06F 11/0778

(57) ABSTRACT

A method for a printer including a transport device including an endless transport belt for a stepwise transport of a print medium in a transport direction from an input roller to a print station and supported on a pair of support rollers, the support rollers define a medium support plane, the print station being provided over the medium support plane, wherein the method comprises the step of repeatedly applying a feedforward to the input roller to get a correct media step.

### CROSS-REFERENCE TO RELATED APPLICATIONS

This application claims priority to European Patent Application No. 25166517.0 filed on Mar. 27, 2025, which is incorporated by reference herein in its entirety.

### Field of the Disclosure

The present disclosure relates to a method for a printer comprising a transport device. The transport device has an endless transport belt that is supported by a pair of support rollers, which between them define a medium support plane, over the medium support plane is provided a print station.

The disclosure also relates to a printer, for example a large format hybrid printer, which comprises a print controller configured to execute the steps of the method according to the present disclosure. The disclosure is also applicable to a roll to roll printer.

A print medium may also be called “print media” or “print media piece” or “medium”. A media step may also be called “step” hereinafter.

### Description of Background Art

In roll to roll applications, web tension is used for a few different purposes, the most important of which being lateral steering and winding quality. Web tension is achieved by different methods in the industry, the most common of which is a dancer, which passively applies a force to the medium.

A feedforward force is applied to the input roller to create a media step in the transport direction. After each media step, the print station is moving perpendicular to the transport direction and ejects marking material to the print medium.

As mentioned, dancers are the most common way to apply web tension, eliminating the need for web tension control. The dancers are, however, a lot more expensive.

Alternatively, web tension is not used at all, but then terrible winding quality is achieved.

A set of media may be calibrated extensively such that the printing system works well for media in the set but worse for other media.

### SUMMARY OF THE DISCLOSURE

The present disclosure is directed to a method for a roll to roll printer that has a direct media connection to its belt and proper web tension.

According to the present disclosure, the print medium is directly connected between the input roller and a fixation belt, meaning that the roll motor has to control the web tension. The variations in the web tension control (especially during stepping) have a direct relationship to registration, and thus print quality.

The method is applied when loading another roll into the printer or when the web of a roll has been cut. When feeding the web of the roll into the printer the steps of the method can be applied.

The printing procedure is considered one step at a time. The medium is moved in the transport direction of the belt step by step. In each step the print head assembly scans the print medium in swaths in the direction perpendicular to the transport direction. In each step, the radius of the input roller is determined, based on the amount of measured rotation of the input roller and belt encoders. Then, while moving, a memory buffer of the error profile is kept during the step, as well as a memory buffer of a few basis functions (e.g. velocity, acceleration, jerk, snap). After the step has finished, the basis functions are run through a process sensitivity, e.g. a transfer function from force input to error, and the measured error is mapped on the reconstructed one. Said mapping yields weights of each of the entered basis functions, which can be used to determine the feedforward for the next step. For each step, the weights are updated until there is no repeated correlation between the error signal and the chosen basis functions. Ideally the actual error would reach zero, but generally there may be any shapes in the error which do not correlate to any of the basis functions and said shapes will remain in the error. However, the shapes that correlate to the basic functions are merely determining the error. Therefore, by doing so, small web tension errors are obtained.

The method is robust to modelling errors, such as uncalibrated media, temperature of the system, etc. The method has a fast convergence, for example only 10-20 media steps are required for convergence. The method is applicable to a larger media range, since media dependencies are taken into account due to the measurement-based approach. Differences between printers are no problem, as the differences are also automatically taken into account. The obtained values can be stored per printer and in a media catalogue to avoid future recalibrations. Data storage is very cheap since implementation of the method may require only a small amount of double type numbers to be stored per media. By observing changes over time, pollution and damage may be identified, aiding predictive maintenance.

The printer according to the present disclosure is a media stepping printing system as opposed to a system running at constant speed. Therefore, maintaining a constant web tension is a challenge as it deals with constant starting and stopping, resulting in inertial forces and stick-slip behaviour.

The present disclosure makes use of a torque-controlled system of the input roller instead of a constant velocity mode drive. Therefore, the position or velocity is not measured, only the force is measured that occurs in the web.

Based on this force (and not on a sampled speed), a right corrective action is determined, which is implemented as a torque instead of as a velocity as well.

Using repeated learning of the web tension feedforward is actually independent of whether torque control or velocity (or even position) control is used. When the input roller is used in torque control mode, the encoder data of the encoders of the input roller is completely ignored.

The method according to the present disclosure measures the error over a specified time (a step) and essentially uses an internal simulation to determine what parameter errors there would have to be in an internal model representing the motion system to obtain the same error. These parameters correspond to specific basis functions, such as velocity, acceleration, jerk and snap, so that it becomes known what changes to the existing feedforward are required to reduce said error for the next step.

The present disclosure also relates to a printer comprising a transport device comprising an endless transport belt supported on a pair of support rollers, which between them define a medium support plane, over which medium support plane is provided a print station, and a print controller configured to execute the steps of present disclosure.

According to an embodiment, the printer is a hybrid printer capable of handling both flexible media and rigid substrates.

According to an embodiment, the printer is a non-hybrid roll-to-roll printer.

According to an embodiment, the printer comprises a user interface for user input of a ready status of the printer and a start printing status of the printer.

The present invention also relates to a software product comprising program code on a machine-readable medium, which program code, when loaded into a print controller of a digital printer according to the present disclosure, causes the print controller to execute the steps of the method according to the present disclosure.

Further scope of applicability of the present disclosure will become apparent from the detailed description given hereinafter. However, it should be understood that the detailed description and specific examples, while indicating embodiments of the present disclosure, are given by way of illustration only, since various changes and modifications within the scope of the present disclosure will become apparent to those skilled in the art from this detailed description.

### BRIEF DESCRIPTION OF THE DRAWINGS

FIG. 1 is a schematic perspective view of a printing system configured to print on rigids according to the present disclosure;

FIG. 2 is a schematic perspective view of a printing system in FIG. 1 configured to print on a roll of media according to the present disclosure;

FIG. 3 is a schematic diagram of a control unit of a printer according to FIG. 1 or 2;

FIG. 4 is a schematic diagram of a feedforward calculation by means of a software package according to the prior art;

FIG. 5 is a schematic diagram of the feedback loop programming according to the method of the present disclosure;

FIG. 6 is a flow diagram of the method according to the present disclosure; and

FIG. 7 is a schematic diagram of a software product according to the present disclosure.

### DETAILED DESCRIPTION OF THE EMBODIMENTS

The present disclosure will now be described with reference to the accompanying drawings, wherein the same reference numerals have been used to identify the same or similar elements throughout the several views.

### Printing System

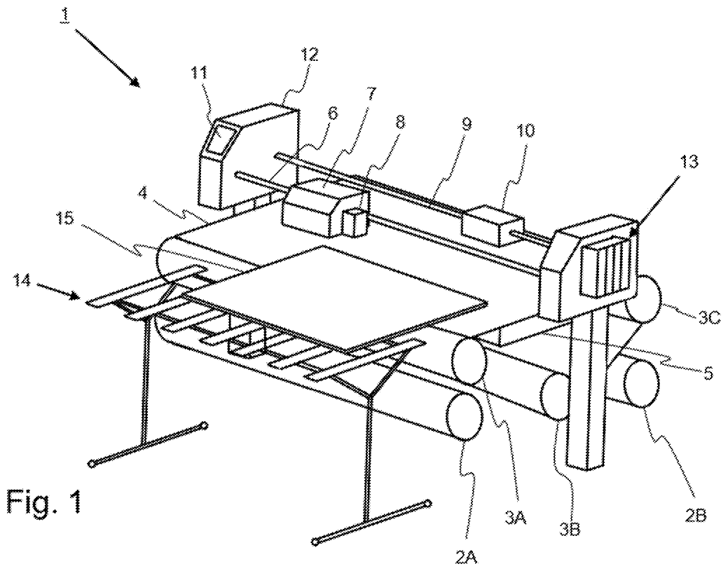

FIG. 1 shows a wide format inkjet printer 1. The wide-format printer 1 comprises an inkjet printing assembly 7 for printing on a print medium 15. The print medium 15 in FIG. 1 is a relatively rigid substrate, such as a panel. The print medium 15 is supplied from a media input unit 14, which may be configured for storing a plurality of such print media 15 and supplying these to the printer 1. The printer 1 comprises transport means for receiving and transporting the print medium 15 along the inkjet printing assembly 7. In FIG. 1, the transport means comprise an endless transport belt 4 supported by a plurality of support rollers 3A, 3B, 3C. At least one of the support rollers 3A, 3B, 3C is provided with driving means for moving the belt 4. Additionally, one or more of the support rollers 3A, 3B, 3C may be configured to be moved and/or tilted to adjust and control the lateral position of the belt 4. The printer 1 is provided with at least one sensor or detector, such as a CCD camera or area camera, to determine the relative position of belt 4 and/or the print medium 15. Data from said at least one sensor or detector may be applied to control the position of the belt 4 and/or the print medium 15. The at least one sensor or detector is positioned in or at a housing (not shown) of the printer 1 and is configured to detect the print medium 15 before transporting the print medium 15 or before the print medium reaches the print station 7. By using cameras, the print medium 15 can be detected over a full width of the medium support plane, and before the print station 7 will start printing on the print medium 15. The at least one sensor or detector can also sense or see alignment bars (not shown) positioned on the media input unit 14 extending towards the medium support plane. According to an alternative embodiment, the at least one sensor or detector is integrated in the medium support plane.

The belt 4 is further provided with through-holes and a suction box 5 in connection with a suction source (not shown), such that a negative pressure may be applied to the print medium 15 via the through-holes in the belt 4. The negative pressure adheres the print medium 15 flatly to the belt 4 and prevents displacement of the print medium 15 with respect to the belt 4. Due to this holding, the belt 4 is able to transport the print medium 15. It will be appreciated that other suitable transport means, such as rollers, steppers, etc., may alternatively be applied. The print medium 15 may be transported stepwise and/or in continuous movement.

The inkjet printing assembly 7 is configured to translate along a first guide beam 6 in a scanning direction. The scanning direction is perpendicular to the direction in which the print medium is transported by the belt 4. The inkjet printing assembly 7 holds a plurality of print heads (not shown), which are configured to jet a plurality of different marking materials (different colors of ink, primers, coatings, etc.) on the print medium 15. Each marking material for use in the printing assembly 7 is stored in one of a plurality of containers arranged in fluid connection with the respective print heads and for supplying marking material to said print heads to print an image on the print medium 15.

The ejection of the marking material from the print heads is performed in accordance with data provided in the respective print job. The timing by which the droplets of marking material are released from the print heads determines their position on the print medium 15. The timing may be adjusted based on the position of the inkjet printing assembly 7 along the first guide beam 6. The above mentioned sensor 8 may therein be applied to determine the relative position and/or velocity of the inkjet printing assembly 7 with respect to the print medium 15. Based upon data from the sensor 8, the release timing of the marking material may be adjusted.

Upon ejection of the marking material, some marking material may be spilled and stay on a nozzle surface of the print heads. The marking material present on the nozzle surface may negatively influence the ejection of droplets and the placement of these droplets on the print medium 15. Therefore, it may be advantageous to remove excess marking material from the nozzle surface. The excess marking material may be removed for example by wiping with a wiper and/or by application of a suitable anti-wetting property of the surface, e.g. provided by a coating.

The marking materials may require treatment to properly fixate them on the print medium. Thereto, a fixation unit 10 is provided downstream of the inkjet printing assembly 7. The fixation unit 10 may emit heat and/or radiation to facilitate the marking material fixation process. In the example of FIG. 1, the fixation unit 10 is a radiation emitter, which emits light of certain frequencies, which interacts with the marking materials, for example UV light in case of UV-curable inks. The fixation unit 10 in FIG. 1 is translatable along a second guide beam 9. Other fixation units 10, such as page-wide curing or drying stations may also be applied. Further, the inkjet printing assembly 7 may be provided with a further fixation unit on the same carriage which holds the print heads. This further fixation unit can be used to (partially) cure and/or harden the marking materials, independent of or interaction with the fixation unit 10.

After printing, and optionally fixation, the print medium 15 is transported to a receiving unit (not shown). The receiving unit may comprise a take-up roller for winding up the print medium 15, a receiving tray for supporting sheets of print medium 15, or a rigid media handler, similar to the media input unit 14. Optionally, the receiving unit may comprise processing means for processing the medium 15 after printing, e.g. a post-treatment device such as a coater, a folder, a cutter, or a puncher.

The wide-format printer 1 furthermore comprises a user interface 11 for receiving print jobs and optionally for manipulating print jobs. The local user interface unit 11 is integrated to the print engine and may comprise a display unit and a control panel. Alternatively, the control panel may be integrated in the display unit, for example in the form of a touch-screen control panel. The local user interface unit 11 is connected to a control unit 12 connected to the printer 1. The control unit 12, for example a computer, comprises a processor adapted to issue commands to the printer 1, for example for controlling the print process. The printer 1 may optionally be connected to a network. The connection to the network can be via cable or wireless. The printer 1 may receive printing jobs via the network. Further, optionally, the control unit 12 of the printer 1 may be provided with an input port, such as a USB port, so printing jobs may be sent to the printer 1 via this input port.

### Hybrid Printing System

The printer 1 in FIG. 1 is a so-called hybrid printer, capable of handling both flexible media and rigid substrates. In FIG. 1, the printer 1 operates in a first print situation, wherein the printer 1 is configured for transporting rigid substrates, such as the print medium 15. Such rigid print media 15 may be panels for doors, walls, etc., corrugated media, plates formed of plastic or metal, etc. To handle these rigid print media 15, the printer 1 in FIG. 1 is configured with a substantially linear transport path: from the media input device 14, the print medium 15 moves forward along the inkjet printing assembly 7 at a substantially constant height. The media input unit 14 and the receiving unit are positioned at the level of the medium support surface of the belt 4.

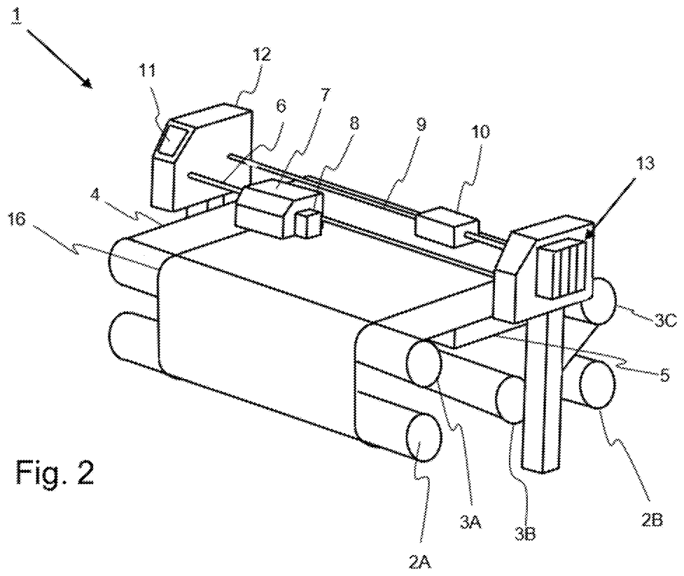

In FIG. 2, a flexible web medium 16 is supplied to the printer 1, which web medium 16 may be composed of e.g. paper, label stock, coated paper, plastic or textile. The web medium 16 is supplied from the input roller 2A and extends across the belt 4 to the take-up roller 2B, where the web medium 16 is re-wound. The printer 1 is configured to swiftly and efficiently switch between print modes.

The input roller 2A is torque controlled. There are two types of control that are considered in the disclosure. Position control is the most common, where a certain position setpoint is compared to an encoder position and feedback is applied to steer the system towards the desired position. Torque control, on the other hand, entails the construction of a torque (or force) setpoint, which is aimed to be followed by the measurement of the torque. In the present disclosure, the torque is in fact the web tension, which is to be kept as constant as possible.

The present disclosure may also be applied to a printer which is non-hybrid and only handles rolls of print media.

### Control

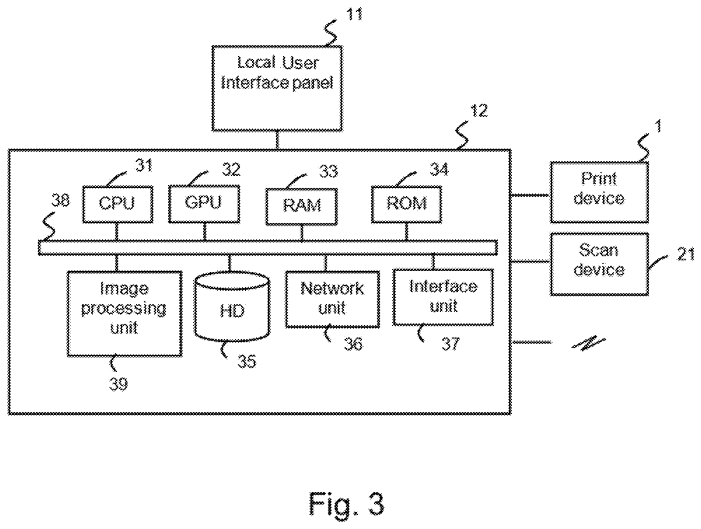

An embodiment of the control unit 12 is presented in more detail in FIG. 3. As shown in FIG. 3, the control unit 12 comprises a Central Processing Unit (CPU) 31, a Graphical Processor Unit (GPU) 32, a Random Access Memory (RAM) 33, a Read Only Memory (ROM) 34, a network unit 36, an interface unit 37, a hard disk (HD) 35, and an image processing unit 39 such as a Raster Image Processor (RIP). The aforementioned units 31-37 are interconnected through a bus system 38. However, the control unit 12 may also be a distributed control unit.

The CPU 31 controls the printing system 1 in accordance with control programs stored in the ROM 34 or on the HD 35 and with the local user interface panel 11. The CPU 31 also controls the image processing unit 39 and the GPU 32. The ROM 34 stores programs and data such as boot program, set-up program, various set-up data or the like, which are to be read out and executed by the CPU 31. The hard disk 35 is an example of a non-volatile storage unit for storing and saving programs and data which make the CPU 31 execute a print process to be described later. The hard disk 35 also comprises an area for saving the data of externally submitted print jobs. The programs and data on the HD 35 are read out onto the RAM 33 by the CPU 31 as needed. The RAM 33 has an area for temporarily storing the programs and data read out from the ROM 34 and HD 35 by the CPU 31, and a work area which is used by the CPU 31 to execute various processes. The interface unit 37 connects the control unit 12 to the client device 21 and to the printer 1. The network unit 36 connects the control unit 12 to the network N and is designed to provide communication with workstations and with other devices reachable via the network N. The image processing unit 39 may be implemented as a software component running on an operation system of the control unit 12 or as a firmware program, for example embodied in a field-programmable gate array (FPGA) or an application-specific integrated circuit (ASIC). The image processing unit 39 has functions for reading, interpreting and rasterizing the print job data. Said print job data contains image data to be printed (i.e. fonts and graphics that describe the content of the document to be printed, described in a Page Description Language or the like), image processing attributes and print settings.

### Learning Web Tension Feedforwarding

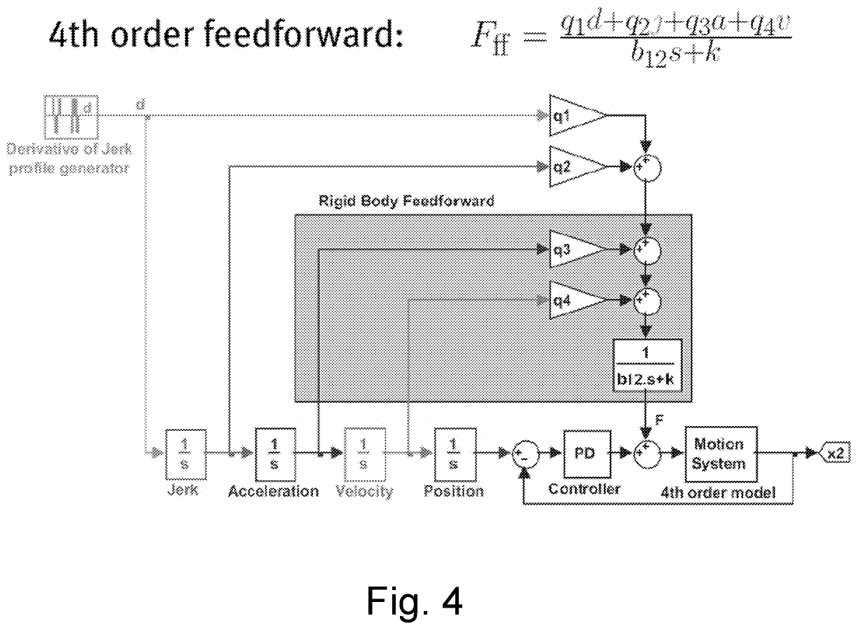

FIG. 4 is a schematic view of prior art. For example, a software package MATLAB & Simulink provide a programming scheme for a 4^{th} order feedforward with inputs a derivative d of a jerk (snap), a jerk j, an acceleration a, a velocity v, and a position s. The inputs deliver a force F_{ff} depending on these inputs. The force F_{ff} is applied to the input roller 2A in FIG. 2.

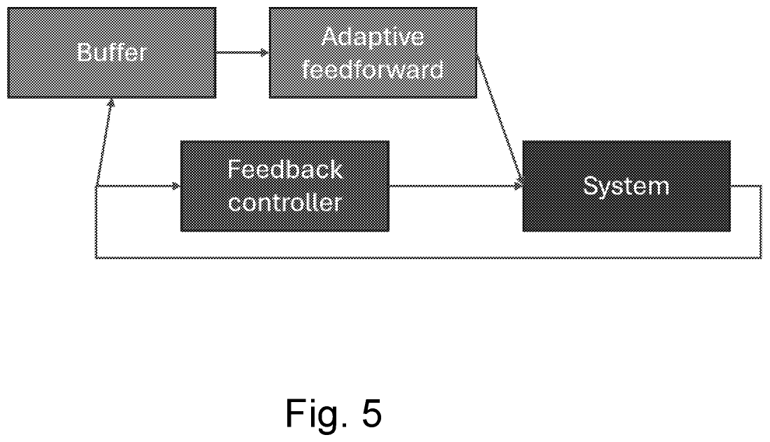

FIG. 5 is a schematic diagram of the feedback loop programming according to the method of the present disclosure. FIG. 5 is a basic feedback scheme, where a system in which the input roller is controlled by a feedback controller. The measured property of the system is the web tension force, from which the feedback controller determines the required motor torque. The basic control scheme is augmented by a buffer and adaptive feedforward. The buffer takes the measured web tension force, as well as the pre-computed values for the basis functions. After each media step, these datasets are fed through the adaptive feedforward algorithm and yield a feedforward force. This is added on top of the feedback motor torque to control the system.

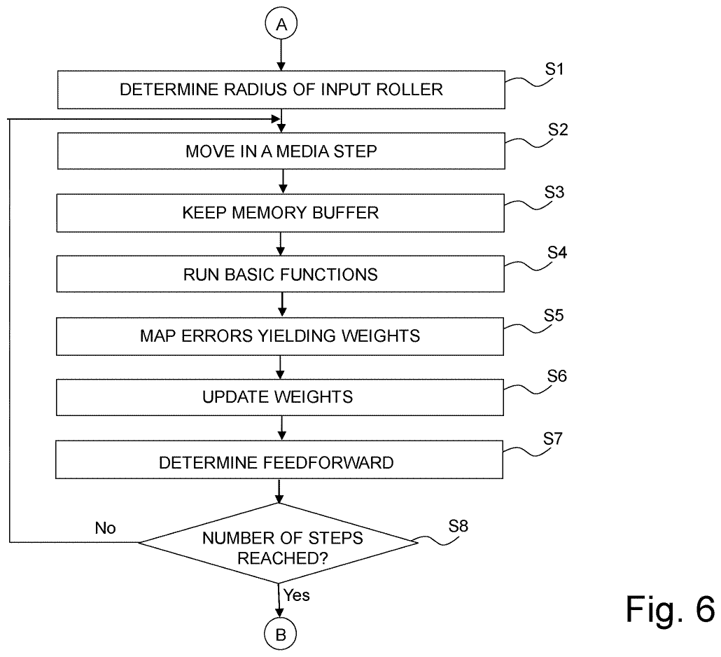

FIG. 6 discloses an example of a method according to the disclosure.

The first method starts in a starting point A which leads to a first step S1.

In the first step S1, the print controller determines a radius of an input web wound up on the input roller, based on the amount of measured rotation of the input web and belt encoders of the endless transport belt.

In a second step S2, the input web is moved in a media step in the transport direction x by applying a feedforward to the input roller 2A.

In a third step S3, while moving the input web in the media step, a memory buffer of an error profile is kept during the media step, as well as of a plurality of basis functions comprising at least a velocity, an acceleration, a jerk and a snap.

In a fourth step S4, after a media step has finished, the basis functions are run through a process sensitivity being a transfer function from a motor torque of the input roller as a force input to a reconstructed error.

In a fifth step S5, an actual error is mapped on the reconstructed error yielding weights of each of the entered basis functions.

In a sixth step S6, the weights are updated.

In a seventh step S7, a feedforward is determined for the next media step by means of the updated weights.

In an eighth step S8, it is checked if a predefined number of media steps has been executed. The inventors have found that a check is not needed that there is no repeated correlation between the actual error and the basis functions. The mathematics of the feedforward step as shown in FIG. 4-5 ensure that a global optimum is found regarding the obtained weights, which means that there can never be correlation left in the final result. If the predefined number of steps has been reached, the method ends in an end point B. If not so, the method returns to the second step S2.

The method ends in an end point B.

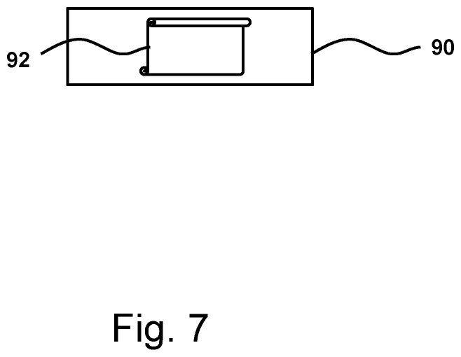

FIG. 7 schematically shows a non-transitory software medium 90 according to the disclosure. The software medium 90 comprises executable code 92 configured to, when executed, perform the method according to the disclosure, e.g. as described with respect to either the printing system 1 shown in FIG. 1 or the method of controlling the printing system 1 according to the present disclosure and/or according to any of the variants and modifications of the printing system 1 and/or of the method described herein.

The non-transitory software medium 90 may, specifically, be formed as a CD or a CD-ROM, a DVD or a DVD-ROM, a BluRay disc or a BluRay-ROM disc, a magnetic hard drive, a solid state disk (SSD) hard drive, a USB memory device and so on.

Although specific embodiments of the disclosure are illustrated and described herein, it will be appreciated by those of ordinary skill in the art that a variety of alternate and/or equivalent implementations exist. It should be appreciated that the exemplary embodiment or exemplary embodiments are examples only and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

It will also be appreciated that in this document the terms “comprise”, “comprising”, “include”, “including”, “contain”, “containing”, “have”, “having”, and any variations thereof, are intended to be understood in an inclusive (i.e. non-exclusive) sense, such that the process, method, device, apparatus or system described herein is not limited to those features or parts or elements or steps recited but may include other elements, features, parts or steps not expressly listed or inherent to such process, method, article, or apparatus. Furthermore, the terms “a” and “an” used herein are intended to be understood as meaning one or more unless explicitly stated otherwise. Moreover, the terms “first”, “second”, “third”, etc. are used merely as labels, and are not intended to impose numerical requirements on or to establish a certain ranking of importance of their objects.

The present disclosure being thus described, it will be obvious that the same may be varied in many ways. Such variations are not to be regarded as a departure from the spirit and scope of the present disclosure, and all such modifications as would be obvious to one skilled in the art are intended to be included within the scope of the following claims.

1. A method for a printer including a transport device including an endless transport belt for a stepwise transport of a print medium in a transport direction from an input roller to a print station and supported on a pair of support rollers, the support rollers define a medium support plane, the print station being provided over the medium support plane, the method comprising:
determining a radius of an input web wound up on the input roller, based on an amount of measured rotation of the input web and belt encoders of the endless transport belt;
moving the input web in a media step in the transport direction by applying a feedforward to the input roller;
while moving the input web in the media step, keeping a memory buffer of an error profile during the media step, as well as of a plurality of basis functions comprising at least a velocity, an acceleration, a jerk and a snap;
after a media step has finished, running the plurality of basis functions through a process sensitivity being a transfer function from a motor torque of the input roller as a force input to a reconstructed error;
mapping an actual error on the reconstructed error to yield weights of each of the basis functions;
determining a feedforward for the next media step by means of the yielded weights; and
updating the weights in each subsequent media step until there is no repeated correlation between the actual error and the basis functions.

2. A printer comprising:
a transport device comprising an endless transport belt for a stepwise transport of a print medium in a transport direction from an input roller to a print station, the print medium being supported on a pair of support rollers thatt define a medium support plane, the print station being provided over the medium support plane; and
a print controller to control printing, wherein the print controller is configured to execute the steps of the method according to claim 1.

3. The printer according to claim 2, wherein the printer is a hybrid printer configured to handle both flexible media and rigid substrates.

4. The printer according to claim 2, wherein the printer is a non-hybrid roll-to-roll printer.

5. The printer according to claim 2, further comprising a torque controlled system of the input roller configured to control the feedforward.

6. The printer according to claim 2, further comprising a user interface configured to receive user input of a ready status and a start printing status of the printer.

7. A non-transitory machine-readable medium storing program code, which when executed by a print controller of a digital printer causes the print controller to execute the steps of the method according to claim 1.
